(19) United States
(12) Patent Application Publication
(10) Pub. No.: US 2008/0317893 A1
(43) Pub. Date: Dec. 25, 2008

(54) INTEGRATED SYSTEM FOR PRODUCING COMPOSITES

(75) Inventor: MARCO GRUBER, Munchen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: KraussMaffei Technologies GmbH, Munchen (DE)

(21) Appl. No.: 12/202,469

(22) Filed: Sep. 2, 2008

Related U.S. Application Data
(63) Continuation of application No. PCT/EP2007/050408, filed on Jan. 16, 2007.

(30) Foreign Application Priority Data
Mar. 3, 2006 (DE) 10 2006 009 900.1

(51) Int. Cl. B29C 45/17

(52) U.S. Cl. 425/149

(57) ABSTRACT

An integrated system for production of composites includes at least one polyurethane unit with a mixing head for mixing a polyol component and an isocyanate component, at least one plasticizing and injection unit, which is suitable for the melting and subsequent injection of a thermoplastic material, and one clamping unit to receive at least one mold. The plasticizing and injection unit and the polyurethane unit can each introduce material to be processed into a mold cavity within the clamping unit. In order to implement a unitary strategy of control and regulation and a unitary approach to operation of this type of integrated system apparatus, a single central control unit and at least one common supply device are provided, with the central control unit being connected at least with the at least one supply device. The at least one common supply device acts at least on both the polyurethane unit and the plasticizing and injection unit.

### CROSS-REFERENCES TO RELATED APPLICATIONS

This application is a continuation of prior filed copending PCT International application no. PCT/EP2007/050408, filed Jan. 16, 2007, which designated the United States and has been published but not in English as International Publication No. WO 2007/101738 and on which priority is claimed under 35U.S.C. §120, and which claims the priority of German Patent Application, Serial No. 10 2006 009 900.1, filed Mar. 3, 2006, pursuant to 35 U.S.C. 119(a)-(d), the contents of which are incorporated herein by reference in its entirety as if fully set forth herein.

### BACKGROUND OF THE INVENTION

The present invention relates, in general, to an integrated system for producing composites.

Combined systems used to date to make plastic composites, in particular composites made from a combination of a polyurethane material with a thermoplastic material include various units which are arranged side-by-side and operated separately. For example, a polyurethane plant with its own supply and controller is typically placed next to a conventional injection molding machine which also has its own supply and controller for producing a PUR thermoplastic composite from a material combination of a polyurethane material with a thermoplastic material. German Pat. No. DE 196 508 54 discloses the option to conditionally connect, the various hydraulic systems, electric supply units and controllers with one another. However, in most cases, separate controllers must be operated and documentation for the data sets and the machine parameters is generally also separately maintained because these entirely different machines and plants, such as injection molding machines and PUR-(polyurethane-) plants, have different control and supply requirements. There are significant differences between the hardware components and the volume of software of injection molding machines and PUR plants.

Because of the separate controllers and supply units, different replacement parts must be inventoried for each system. Moreover, an interface between, for example, an injection molding machine and a PUR plant is also limited to the exchange of only a small number of essential signals and parameters. The functions of the respective controllers must typically be monitored separately; likewise, the entire plant must in most cases also be operated separately. This complicates operation so that the plant can be operated only by well-trained personnel. The control philosophy which is tailored to the various units must also be considered, which makes operating and monitoring the plant more difficult.

It would therefore be desirable and advantageous to address prior art shortcomings and to provide a uniform control concept as well as a uniform operating philosophy for a plant to produce composites.

### SUMMARY OF THE INVENTION

According to one aspect of the present invention, an integrated system for producing composites includes a clamping unit configured for receiving at least one mold, at least one polyurethane unit with a mixing head for mixing a polyol component and an isocyanate component, at least one plasticizing and injection unit configured for melting and subsequently injecting a thermoplastic material, wherein both the at least one plasticizing and injection unit and the at least one polyurethane unit are configured for introducing the thermoplastic material into a mold cavity of the at least one mold, a common hydraulic supply device and a common electric supply system jointly operating the polyurethane unit and the plasticizing and injection unit, and a single central controller connected to the common hydraulic supply device and the common electric supply device.

The present invention resolves prior art problems by providing only a single central controller for the entire integrated system, and at least one common supply device which is connected with the central controller. The at least one common supply device supplies jointly at least the polyurethane unit (PUR unit) and the plasticizing and injection unit. In contrast to conventional strategy to separately operate the various units, such as the polyurethane unit and the plasticizing and injection unit, the present invention teaches a path, using an overall integrated control and at least one common supply device to provide uniform documentation and a common controller. In addition, a truly integrated plant consisting of a PUR unit and an injection molding unit can be established for the first time.

The supply device can be a common hydraulic supply device, a common pneumatic supply device and/or an electric supply system. The different components of the integrated system, such as the polyurethane unit, the plasticizing and injection unit and the clamping unit each include a plurality of drives, switching and adjustment possibilities, which are supplied with the corresponding supplies by the common supply devices.

The plasticizing and injection unit requires at least for the rotation of plasticizing screws a rotary drive, which may be implemented hydraulically, electrically and less frequently also pneumatically. The injection unit also works predominately hydraulically or electrically. The central controller can directly control the metered supply of material to a plasticizing unit in order to attain the desired volume flow of material into the plasticizing unit. The injection unit is typically also pressed against the platen or a mold during the injection process, wherein the clamping force is predominantly also realized with a hydraulic or an electric drive. Other loads can be energized in addition to these drives, such as a heating device, a switching device or drive source.

During opening or closing, the clamping device is mostly operated electrically or hydraulically. The clamping pressure is often applied hydraulically, or when using a toggle lever, also electrically. In addition, ejector devices are located in the region of the clamping unit, which are also operated electrically or hydraulically, optionally also pneumatically. Moreover, core pullers should also be mentioned in the context with molds, which are also mostly operated hydraulically or pneumatically. Also mentioned should be temperature control devices in the region of the mold, which also need to be controlled and operated.

On the side of the polyurethane device, the mixing heads can be operated hydraulically or electrically. Also provided are pumps for supplying the polyurethane components to the mixing head, which are normally operated electrically.

This is only a selection of the different operating requirements of the respective elements and drives of the units of an integrated system. These examples illustrate the multitude of possible different combinations.

The present invention provides for the entire system only a single common supply device of a certain type, i.e. for the hydraulic and/or for the pneumatic and/or for the electrical unit. Two different hydraulic supply devices, two different pneumatic supply devices or two or more different electrical supply devices can then be eliminated, which also reduces the maintenance requirements.

The respective common supply devices are connected with the central controller, which then controls the entire system and therefore also obtains by way of the different sensors also an overview over the various processes running in the system. The central controller is connected to the supply devices not only for the purpose of operating the supply devices, but the central controller can also be directly connected to individual components of the polyurethane unit, of the plasticizing and injection unit, of the clamping unit and of other units.

An integrated system for producing a composite, in particular a composite made of polyurethane and thermoplastic, can include a clamping unit, one or more plasticizing and injection units for producing one or more thermoplastic components or one or more thermoplastic layers, in part with different materials and one or several polyurethane units for producing one or more PUR components or layers.

The polyurethane unit can include a metering module for a measured addition of liquid polyurethane components, such as polyol and isocyanate and optionally other additives, a mixing head for mixing the polyurethane components. Optionally, one or more dye modules for separate dye metering can be integrated in the polyurethane components. Optionally, a gas metering station can be added for supplying gas to one or several of the polyurethane components or of the polyurethane mixture.

As the polyurethane material can generally strongly adhere to the walls of the cavity, the walls can advantageously be wetted with a release agent before the polyurethane mixture is introduced. For this purpose, a device for introducing such release agent may advantageously be provided. The device may include, for example, a robotic arm with a rinsing nozzle on its front end, which can optionally be moved across the cavity wall using the robotic arm.

Depending on which drives are implemented hydraulically, the common hydraulic supply device can be designed to operate the clamping unit, the polyurethane unit, the plasticizing and injection unit, the PUR mixing head, the different pressing devices, the gas metering station or the dye modules. If the different drives are operated pneumatically, then the common pneumatic supply device can be configured to also control the clamping unit, the plasticizing and injection unit, the pressing units, the polyurethane mixing head, the gas metering station, the dye modules or the device for applying a release agent. This applies similarly to the entire electric system, if the system includes individual electric drives or electric switching and adjusting elements.

The polyurethane mixing head should be able to move towards and away from the clamping unit or the mold. Advantageously, a mounting and travel device with at least the PUR mixing head is provided. The mounting and travel device makes it easier to handle the PUR mixing head in the overall system. The PUR mixing head can be docked and pressed onto a sprue channel of a mold by a pressing device, for example a hydraulic or pneumatic cylinder or also an electric motor. In addition, the mixing head can be lifted from the mold after each cycle or only at specified times, which facilitates cleaning of the polyurethane sprue region. The PUR mixing head can also be tested with the mounting and travel device directly on the machine without having to remove the mixing head. If the PUR mixing head is retracted, PUR empty charges can be performed. The mixing chamber nozzles of the mixing head are then also easily accessible. The mixing chamber nozzles which need to be changed according to the production parameters can then be exchanged directly on the machine without having to completely dismantle the PUR mixing head. If, depending on the application, different PUR mixing heads are to be used, then an adapter plate can be provided which is preferably applied on a standard housing of a clamping unit. A two-component injection molding machine can thereby be flexibly configured for processing with a PUR processing unit, wherein the second plasticizing and injection device only needs to be exchanged for a PUR unit.

Advantageously, the PUR mixing head can be mechanically locked on the mold. If a malfunction or an unexpected event occurs during the PUR injection cycle, the mixing head can then not be pushed out of its position.

The polyurethane mixing heads typically include a mixing chamber piston and frequently also a cleaning piston, which are frequently controlled hydraulically by a hydraulic system of a metering device. In conventional PUR units, the hydraulic valves required for switching are frequently obstructed in the region of the metering device and connected with long hydraulic connecting lines with the mixing head. This poses a problem for a precisely controlled timing of the mixing piston and the cleaning piston, because the long hydraulic lines make a precise control more difficult (e.g., problem of “hose breathing” due to trapped air in the lines). With the integration into the overall system, the control valves can now be placed directly in the region of the mixing head, allowing for very short control lines. This increases the system pressure, because of the pressure loss in the short lines can be kept small. The frequently cumbersome venting of the mixing head hydraulics is also eliminated. In addition, the mixing head hydraulics can use small and compact quick-connect systems.

The common hydraulic supply device can be implemented with separately operating system circuits. At least one system circuit should be used here for the polyurethane unit and another system circuit for the plasticizing and injection unit.

As an alternative to hydraulically operated polyurethane mixing heads, this component can also be operated solely electrically. For example, the mixing chamber piston and the optional cleaning piston can be directly controlled by electric motors, preferably by so-called high torque electric motors. The PUR mixing head would then no longer include hydraulic components. A control with electric motors significantly improves the precision with which the piston can be controlled, in particular with respect to positioning accuracy and velocity control. The precise control with electric motors would then also allow control of cleaning piston in the PUR mixing head as a function of the distance during the injection process (charge). The cleaning piston can then be precisely opened and closed as a function of the position during the entire PUR charge, which allows control of PUR mixing during a charge. This is also not possible with today's conventional hydraulic controls.

By employing electric motor for operating the PUR mixing head, the cleaning piston can be controlled as a function of the pressure during the charge, for example, by measuring the torque on the electric motor. The cleaning piston can be opened and closed depending on the counterpressure in the cleaning chamber during the charge process, allowing control of PUR mixing during the charge. This is also not possible with today's conventional hydraulic controls.

The cleaning piston in the PUR mixing head can also be controlled during the charge as a function of the velocity based on a velocity control of the electric motor. The cleaning piston can thus be controlled as a function of the velocity when a charge is supplied.

Of course, several plasticizing and injection devices can be combined with several polyurethane units. These different units can be placed around the clamping unit at conventional locations (piggyback, vertical, L-position, etc.).

The PUR unit can also be arranged at different positions with respect to the clamping unit and the plasticizing and injection unit. For example, as described below, the PUR unit can be attached—in relation to the clamping unit—opposite to the plasticizing and injection unit. The PUR unit can also be attached on the same side as the plasticizing and injection unit, for example in a piggyback configuration. The PUR unit can also be arranged above, below, or on the side of the clamping unit, either associated with a fixed platen, a movable platen or an intermediate platen. With this arrangement, the PUR unit can be mounted directly on the platen or intermediate platen or on a frame that is fixed or movable with respect to the platen or the intermediate platen.

The clamping unit itself can be implemented in many ways. Minimally, two platens are provided on which the mold halves are mounted. These two platens must move towards each other or away from each other for opening and closing the mold. For example, in one embodiment, an intermediate platen, in particular in form of a horizontally or vertically rotatable turning plate, is arranged between the two platens. With such an arrangement, two molds forming different cavities can be received in the clamping unit, wherein a thermoplastic body can be formed in the first cavity and a PUR coating can be formed in the second cavity. It will be understood that more than two platens may be associated with a horizontally rotatable turning plate, so that a corresponding number of molds can be placed. The clamping unit can also include a rotary table arrangement, which can be mounted on to or integrated in a platen, so that one or more mold halves can be rotated. Such rotary table arrangements are known in the art. Alternatively or in addition to the rotary table arrangement, a linearly movable table may be implemented, wherein the mold halves can be moved in a lateral direction. The clamping unit can also include an indexing plate allowing movement of the mold regions.

One or more dye modules can be placed directly adjacent to the polyurethane mixing head for the purpose of dye metering. The dye lines can then be kept short, enabling a simple and quick change of the dye modules. The short dye lines also improve the precision and reproducibility of dye metering. Moreover, a dye change requires less cleaning due to the short length of the dye lines.

The clamping force on the mold can also be controlled as a function of certain parameters. For example, the clamping force can be controlled as a function of the PUR injection pressure in the mixing head. For example, venting at the beginning of a charge can be supported with a low clamping force. At the end of the charge, when the maximum pressure is reached, the clamping force can be increased to a maximal value in order to prevent overspraying.

Another advantage is temperature control of the mold during the operation of the polyurethane unit. For example, the temperature of the mold can be kept low when polyurethane is introduced. Low temperatures significantly delay the onset of the immediately starting cross-linking reaction. As a result, the filling process can be performed more slowly and at a lower pressure. The low pressure also prevents overspraying of the cavity. At the end of the charge, the mold is abruptly heated, thereby still achieving a rapid reaction time.

The disclosed integrated system can be flexibly employed. For example, parts of the PUR unit can also supply another integrated plant. For example, the containers for the PUR starting materials, the pumps, the metering module, etc., can also be used for other integrated systems which each have an corresponding mixing head.

The PUR mixing head could also be removed as needed and operated separately. Likewise, if required by the application, the mixing head or the plasticizing and injection unit can be operated separately, while the respective other system part is deactivated. Moreover, the plasticizing and injection unit and the PUR unit can be operated in a master-slaves mode, wherein several plants may be controlled or regulated with a synchronous cycle. The plasticizing and injection unit can then operate, for example, as a master.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of an integrated system according to the present invention;

FIG. 2 is an enlarged view of a mounting and travel unit of the integrated system of FIG. 1; and

FIG. 3 is a top view of a modified integrated system, wherein the clamping unit is now implemented with a turning plate.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

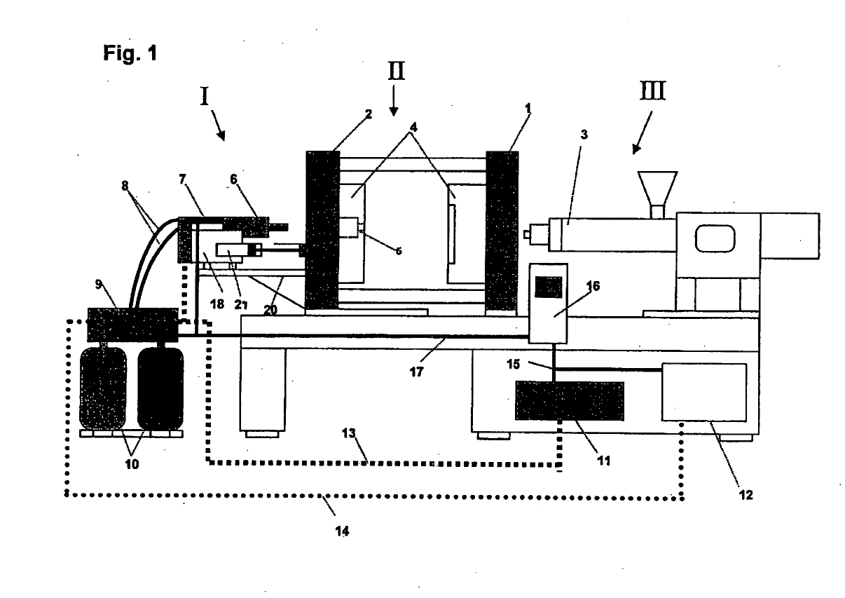

Turning now to the drawing, and in particular to FIG. 1, there is shown a schematic diagram of an integrated system according to the present invention. The integrated system includes essentially three large areas, namely a polyurethane unit I, a clamping unit II, and a plasticizing and injection unit III. The plasticizing and injection unit III is implemented in a conventional manner, and includes a plasticizing screw (not shown in detail) which is rotatable and moveable received in a plasticizing cylinder. The plasticizing unit (also reference symbol 3) is received on a machine bed which also supports the clamping unit II. An electric drive is arranged on the rear end (in FIG. 1 the right end) of the plasticizing and injection unit III, which rotates the plasticizing screw and also moves the plasticizing screw back and forth (drive for the injection).

Starting material for the plasticizing and injection unit III is introduced via a feed hopper. This material is subsequently melted and—when sufficient molten material has accumulated in an antechamber of the screw—injected into a cavity of a closed mold 4. In the present example, only a single drive is indicated in the plasticizing and injection unit III. However, a number of additional drives can be provided, such as a drive for pressing the unit against a mold.

The clamping unit II according to FIG. 1 includes two platens 1 and 2, with a respective mold half of mold 4 mounted on each of the platens 1, 2. In the present example, the platen 2 shown on the left (in FIG. 1) is configured for back and forth movement, so that the mold 4 can be closed and opened by moving this platen 2. A cavity is formed in the mold 4, in which the thermoplastic material can be injected when the mold is closed.

The polyurethane unit I is shown in the left part of FIG. 1. It includes a PUR mixing head 6 which is connected via component lines 8 with the metering module for the polyurethane components. The metering module is in turn coupled to two containers 10 for the polyurethane components polyol and isocyanate.

In the present example, the mixing head is arranged on a mounting and travel device 18, which can be moved on a platform 20 towards the front (towards the platen 2) and back (away from the platen 2). The platform 20 is fixedly connected to the movable platen 2. The mounting and travel device 18 also receives the control module for the PUR mixing head, which is interposed between the component lines and the mixing head 6 and performs a switching function for supplying the polyurethane components to the mixing head 6.

The mounting and travel device 18 is connected via an intermediate drive 21 with the movable platen 2 so that during operation of the drive 21, the mounting and travel device together with the mixing head 6 arranged thereon can be moved toward and away from the platen 2. The drive 21 is also configured so that the mixing head 6 can be pressed against the mold half of mold 4 in the region of the polyurethane sprue 5. The hydraulic drive 21 in the present embodiment is hence configured with a piston-cylinder drive unit, wherein one end is attached to the platen 2 and another end to the mounting and travel device.

The integrated system according to the invention illustrated in FIG. 1 includes a central controller 16 as well as a common hydraulic supply device 11 and a common electric supply unit 12. Both the hydraulic supply device and the electric supply unit are connected directly to the central controller 16 from which they receive corresponding control commands. The central controller 16 is also directly, but separately connected to the different components which it also controls directly. In the present example, the central controller 16 is directly connected to the metering module 9 and the actuator module 7. Additional control and switching elements can receive control commands directly from the central controller 16. The central controller 16 can also be connected to sensors for receiving information. However, such sensors and connections are not illustrated herein.

The common hydraulic supply device 11 is also connected with the actuator module 7 and the metering module 9. Not illustrated are additional connections, for example to the drive of the clamping unit 2 or to the ejector for the clamping unit or possibly to the plasticizing and injection unit 3.

The common electric supply unit 12 is in the present embodiment connected to the metering module 9 and the drive for the plasticizing and injection unit 3.

The integrated system can now be controlled, operated and monitored by a single central controller 16, so that a uniform operating philosophy for the entire system can be realized. Moreover, a single hydraulic supply device and electric supply unit is required and not different, separate hydraulic and electric supply devices, as with conventional systems.

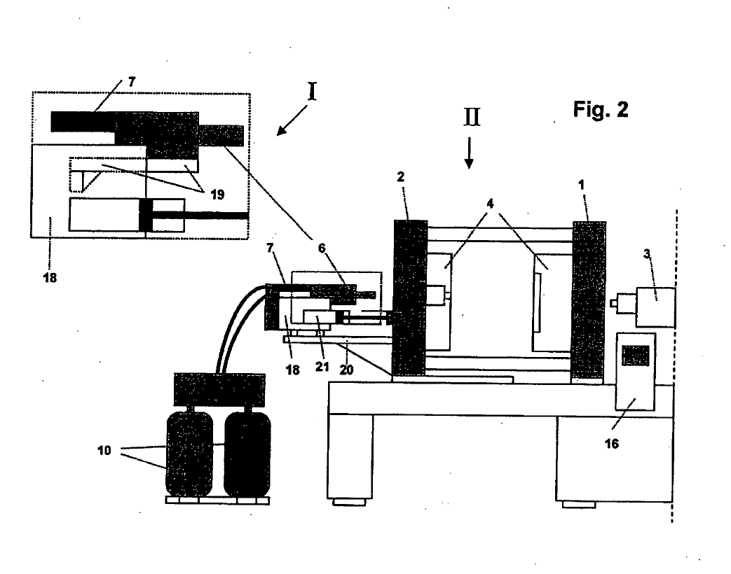

FIG. 2 shows again a part of the integrated system depicted in FIG. 1, wherein the region of the mounting and travel device is schematically illustrated in the upper left part of FIG. 2 on an enlarged scale. It is evident that the mixing head 6 together with the actuator module for the polyurethane mixing head is releasably attached on the adapter 19 with a coupling. By using the adapter 19, different types of mixing heads can be directly coupled with the mounting and travel device 18. The integrated system can hence be flexibly employed.

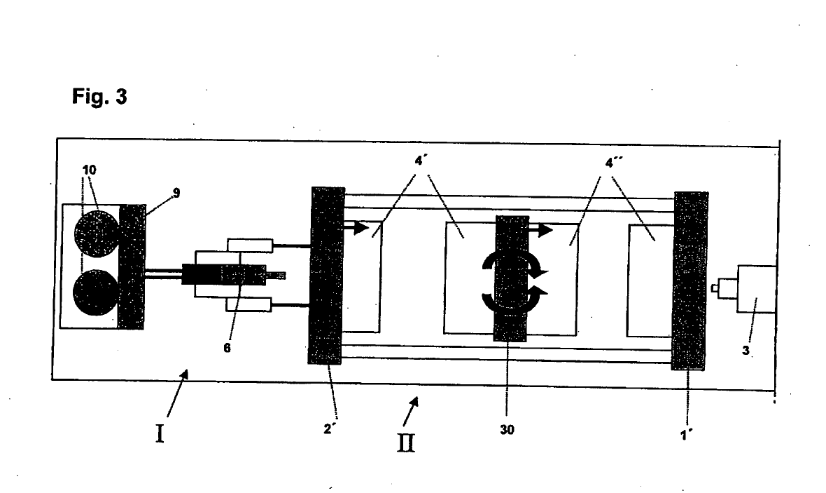

FIG. 3 shows a schematic top view on a modified integrated system, wherein unlike in the system depicted in FIG. 1, a turning plate rotary device 30 is arranged between the two platens 1′ and 2′ of the clamping unit II′. Molds are arranged between the platen 1′ and the turning plate 30 as well as between the platen 2′ and the turning plate 30. The molds can be closed by moving the movable platen 2′ and the turning plate 30 towards the platen 1′ and can be opened by moving in the opposite direction. With the system shown in FIG. 3, thermoplastic materials coated with polyurethane can be cyclically formed, wherein, in a first step, a thermoplastic product is formed in the mold 4″. After the clamping unit II′ is opened, the turning plate is rotated by 180°, wherein the molded thermoplastic part produced in the cavity of the mold 4″ is carried along in the mold of the turning plate, and the clamping unit is closed again. By suitable designing the mold half of the mold 4′ on the side of the platen, a cavity (an enlarged cavity) is formed between the thermoplastic product remaining in the turning plate and the other cavity wall, in which the polyurethane material is then injected into a cavity between the mold and the thermoplastic product received in the cavity by way of the attached mixing head 6. The thermoplastic product is then overflooded or coated and a multilayer part consisting of a thermoplastic material and a polyurethane surface is formed.

With the present invention, an integrated system with a polyurethane unit and a plasticizing and injection unit can be operated with a single, common hydraulic system or a single common electrical system. This provides substantial cost and space savings compared to conventional systems which each have their own hydraulic systems and electrical supply units. By reducing the number of components and the common use of hydraulic, electric, pneumatic and control modules, a significant cost advantage is attained. This also simplifies the operation by a uniform control concept, which reduces expenses for training personnel. The extensive cooperation also improves process control and process precision, which enhances stability. Finally, less waste is generated during production and energy consumption is also reduced.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An integrated system for producing composites, comprising:
a clamping unit configured for receiving at least one mold;
at least one polyurethane unit with a mixing head for mixing a polyol component and an isocyanate component;
at least one plasticizing and injection unit configured for melting and subsequently injecting a thermoplastic material, wherein both the at least one plasticizing and injection unit and the at least one polyurethane unit are configured for introducing the thermoplastic material into a mold cavity of the at least one mold;
a common hydraulic supply device and a common electric supply system jointly operating the polyurethane unit and the plasticizing and injection unit; and
a single central controller connected to the common hydraulic supply device and the common electric supply device.

2. The integrated system of claim 1, wherein a common hydraulic supply device or a common pneumatic supply device or a common electrical supply system, or a combination thereof, are provided as a supply device.

3. The integrated system of claim 1, wherein at least one of the supply devices also acts upon the clamping unit.

4. The integrated system of claim 1, wherein the central controller is configured to control the polyurethane unit and the plasticizing and injection unit.

5. The integrated system of claim 4, wherein the central controller is configured to directly or indirectly control the clamping unit.

6. The integrated system of claim 1, wherein the polyurethane unit comprises a metering module, which is acted on by the central controller or the at least one supply device, or a combination thereof.

7. The integrated system of claim 1, wherein the polyurethane unit comprises at least one mixing head.

8. The integrated system of claim 7, wherein the at least one mixing head is configured to be exchanged by an adapter device.

9. The integrated system of claim 1, further comprising a travel device, wherein at least the mixing head is arranged on the travel device configured for back and forth movement relative to a mold.

10. The integrated system of claim 2, further comprising a travel device, wherein the travel device is configured for back-and-forth movement and coupled to a drive which is acted on by the supply device.

11. The integrated system of claim 1, wherein the polyurethane unit comprises at least one dye module which is configured for metered addition of a dye to the thermoplastic material.

12. The integrated system of claim 1, wherein the polyurethane unit comprises at least one gas metering station which is configured for metered addition of a gas to the thermoplastic material.

13. The integrated system of claim 1, further comprising a device for applying a release agent on a surface of a mold half.

14. The integrated system of claim 1, wherein the common hydraulic supply device acts upon at least two units selected from the group consisting of the clamping unit, the at least one plasticizing and injection unit, the at least one polyurethane unit, a travel device, a gas metering station, and a dye module.

15. The integrated system of claim 2, wherein the common pneumatic supply device acts upon at least two units selected from the group consisting of the clamping unit, the at least one plasticizing and injection unit, the at least one polyurethane unit, a gas metering station, a dye module and a travel device and a device for applying a release agent.

16. The integrated system of claim 1, wherein the common electrical system acts upon at least two units selected from the group consisting of the clamping unit, the at least one plasticizing and injection unit, the at least one polyurethane unit, a travel device, a gas metering station, a dye module and a device for applying a release agent.

17. The integrated system of claim 1, wherein the central controller directly acts upon at least two units selected from the group consisting of the clamping unit, the at least one plasticizing and injection unit, the at least one polyurethane unit, a travel device, a gas metering station, a dye module and a device for applying a release agent.

18. The integrated system of claim 1, wherein the polyurethane unit comprises a pressing device for pressing the mixing head against a mold, wherein the pressing device is operated hydraulically, pneumatically, or electrically, or a combination thereof.

19. The integrated system of claim 1, further comprising a locking device for mechanically releasably coupling the mixing head to a mold or a platen.

20. The integrated system of claim 1, wherein the common hydraulic supply device has at least two separate system circuits, of which one system circuit is associated with the at least one polyurethane unit and another system circuit is associated with the at least one plasticizing and injection unit.

21. The integrated system of claim 1, wherein the mixing head is exclusively driven by an electric drive.

22. The integrated system of claim 21, wherein the mixing head further comprises a mixing chamber piston or a cleaning piston, or both, which are driven by an electric motor.

23. The integrated system of claim 22, wherein the electric motor is connected with the mixing head by way of a quick-action coupling system.

24. The integrated system of claim 21, further comprising a device for measuring a torque of the electric drive, wherein a torque signal measured by the device is supplied to the central controller.

25. The integrated system of claim 21, further comprising a device for measuring a speed of the electric drive, wherein a speed signal measured by the device is supplied to the central controller.

26. The integrated system of claim 1, wherein the clamping unit comprises an intermediate plate in form of a rotatable turning plate.

27. The integrated system of claim 1, wherein the central controller is configured for controlling a clamping force of the clamping unit.

28. The integrated system of claim 27, wherein the central controller controls the clamping force as a function of a polyurethane injection pressure in the mixing head.

29. The integrated system of claim 1, further comprising an annealing device for the at least one mold, wherein the annealing device is connected with the central controller which controls the annealing device.

30. The integrated system of claim 29, wherein the central controller controls a temperature as a function of a fill of a mold cavity.

31. The integrated system of claim 1, wherein the clamping unit comprises at least one platen implemented as a rotatable platen.

32. The integrated system of claim 1, wherein the clamping unit comprises a sliding table to enable lateral displacement of mold halves.

33. The integrated system of claim 1, wherein the clamping unit comprises an indexing arrangement for deploying and displacing mold regions of a mold.

34. The integrated system of claim 9, wherein the travel device for the mixing head is mounted, in relation to the clamping unit, on the same side as the at least one plasticizing and injection unit, or on the opposite side of the at least one plasticizing and injection unit, or above the clamping unit, or on the side of the clamping unit, or below the clamping unit, or below an intermediate plate.

35. The integrated system of claim 1, wherein the polyurethane unit is configured such that parts of a polyurethane unit can also supply another integrated system.

36. The integrated system of claim 1, wherein the central controller is configured as a master-slave controller, allowing synchronous control of the operating cycle of the at least one polyurethane unit and the at least one plasticizing and injection unit.
